(19) United States
(12) Patent Application Publication
(10) Pub. No.: US 2011/0181569 A1
(43) Pub. Date: Jul. 28, 2011

(54) Electro-optic display and related driving method thereof

(76) Inventors: WEI-TING LIU, Hacienda Heights, CA (US); WEI-HUA LU, Taipei (TW); CHIH-KUEI HU, Jubei (TW)

(21) Appl. No.: 12/693,459

(22) Filed: Jan. 26, 2010

(51) Int. Cl. G09G 5/00; G09G 3/34

(52) U.S. Cl. 345/208; 345/107; 345/204

(57) ABSTRACT

The present invention discloses an electro-phoretic display comprising an electro-phoretic panel, a column driver, a row driver, for selecting a row to be driven; and a controller, for determining whether to update a pixel of a current frame according to a compared result between a pixel value of the pixel and a pixel value of a corresponding pixel of a previous frame; wherein, the column driver provides a data signal to the pixel and the row driver provides a selecting signal according to the pixel if the pixel needs to be updated.

### BACKGROUND OF THE INVENTION

1. Field of the Invention

The present invention relates to an electro-phoretic display, and more particularly, to an electro-phoretic display with low power consumption.

2. Description of the Prior Art

For displaying information on a display in early days, people utilized cathode ray tube (CRT) to display information. As CRT display is big in size and heavy in weight, a thin and light display is highly demanded. Currently, the most popular display is liquid crystal display (LCD) which is thin in size and light in weight.

LCD is largely utilized in many fields, not only for large size display, e.g. television, monitor, but also for small size display, e.g. personal digital assistant, camera. Although LCD is very convenient for display purpose, it needs to be refreshed constantly. The liquid crystal material needs to turn its polarity many times in one second to avoid polarized. Because of this property of liquid crystal, power consumption is hard to lower down. For today's electronics, a long battery life and low power consumption is highly demanded. A new material for display and new driving method is needed for this demand.

### SUMMARY OF THE INVENTION

It is therefore a primary objective of the claimed invention to provide an electro-phoretic display with updating pixel that the pixel value of the pixel of a current frame is different from the pixel value of a corresponding pixel of a previous frame, and not updating at least one pixel of the current frame in order to lower the power consumption when updating the display data.

According to an objective of the present invention, the present invention discloses an electro-phoretic display comprising an electro-phoretic panel, a column driver, a row driver, for selecting a row to be driven; and a controller, for determining whether to update a pixel of a current frame according to a compared result between a pixel value of the pixel and a pixel value of a corresponding pixel of a previous frame; wherein, the column driver provides a data signal to the pixel and the row driver provides a selecting signal according to the pixel if the pixel needs to be updated.

The present invention also discloses a display system comprising a data receiver, for receiving an image data; the image data comprising an initial frame and a difference frame; wherein the difference frame and the initial frame define a second frame; an electro-phoretic display comprising an electro-phoretic panel, a column driver, a row driver and a timing controller, for controlling the column driver and the row driver to display the initial frame on the electro-phoretic panel and updates a plurality of pixels of the initial frame according to the difference frame to display the second frame.

The present invention further discloses a method of driving an electro-phoretic display comprising driving the electro-phoretic display to display a previous frame, determining whether to update a pixel of a current frame according to a compared result between a pixel value of the pixel of a current frame and a pixel value of a corresponding pixel of a previous frame.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is two different pages of an article.

FIG. 2 is the same two different pages of an article of FIG. 1 with region marks.

FIG. 3 is zoom-in of text region of different frames, overlap frame and difference frame.

FIG. 4 is a schematic diagram of an electro-phoretic display with controller, timing controller and cascading data driver according to an embodiment of the present invention.

FIG. 5 is a schematic diagram of an electro-phoretic display with timing controller and cascading data driver according to an embodiment of the present invention.

FIG. 6 is a schematic diagram of an electro-phoretic display with controller, timing controller and point-to-point data driver according to an embodiment of the present invention.

FIG. 7 is a schematic diagram of an electro-phoretic display with timing controller and point-to-point data driver according to an embodiment of the present invention.

FIG. 8 is a diagram of XOR gate and its truth table.

FIG. 9 shows an exemplified controller according to the present invention.

FIG. 10 shows an exemplified controller according to the present invention.

FIG. 11 shows an exemplified controller according to the present invention.

FIG. 12 shows an exemplified controller according to the present invention.

FIG. 13 is a schematic diagram of an electro-phoretic display with a controller, a timing controller and a memory according to an embodiment of the present invention.

FIG. 14 is a schematic diagram of an electro-phoretic display with a timing controller and a receiver according to an embodiment of the present invention.

FIG. 15 is a flowchart of an updating a pixel according to comparing a pixel value of a pixel of a current frame with a pixel value of a corresponding pixel of a previous frame of the present invention.

### DETAILED DESCRIPTION

Traditionally, for example, in an LCD display, when a user reads a book or browses a web on an electro-phoretic display, the whole frame of the display needs to be updated if the user changes to another page or changes to another website. Because the LCD display has to update all pixels of the frame, that will consume much unnecessary power.

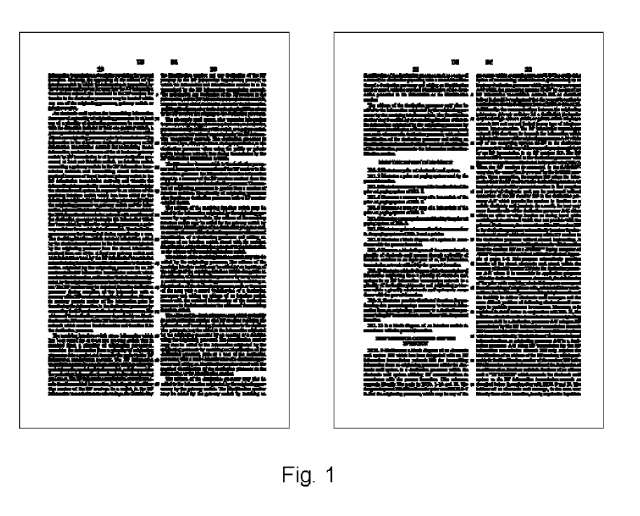

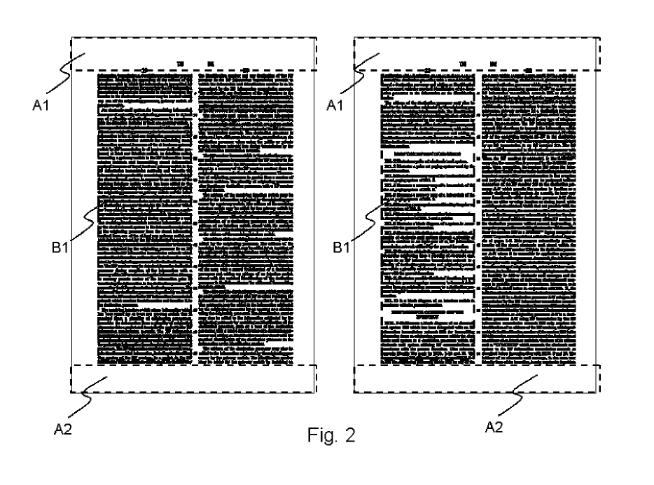

Therefore, the present invention provides a novel electro-phoretic display and related driving method for updating pixels when the frame changes. Please refer to FIG. 1, which shows two different pages of an article. When a user changes page between these two pages, some areas of these two pages are holding unchanged. In general, a page of a book may have upper region, lower region, left region and right region; these regions are kept white with only page number and chapter title on the lower region and the upper region. The central region is the text region or figure region, and normally it has its fix dimension and position especially for the text region. As shown in FIG. 2, the upper region A1 and the lower region A2 are either white or with few texts on it. Both of these two pages are quite similar in these regions. But in the text region B1, the main difference between these two pages falls in this region.

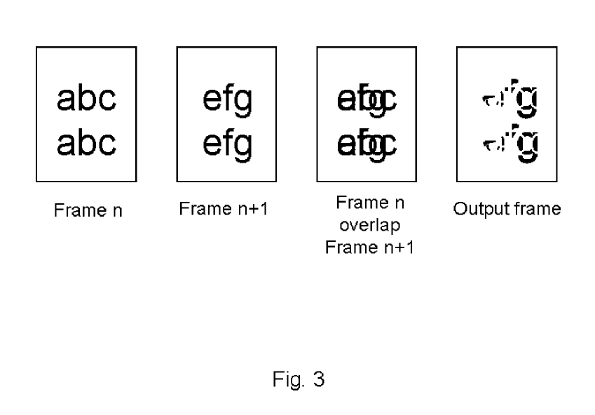

Please refer to FIG. 3, which is an example of the zoom-in text region B1 of FIG. 2. In the text region, texts are arranged into different text lines, and there are spaces between these text lines. Normally, these spaces between text lines have similar positions between two pages, and the text lines have similar positions too. When compared Frame n with Frame n+1 of the FIG. 3, there are many pixels holding unchanged. The pixels which need to be updated from white to black are shown in the Output Frame of FIG. 3 (pixels which need to be updated from black to white are similar, and omitted therein), and in comparison to the whole area, only a few pixels need to be updated. The power consumption of electro-phoretic display is mainly caused by updating pixels, so if fewer pixels need to be updated, lower power consumption can be achieved.

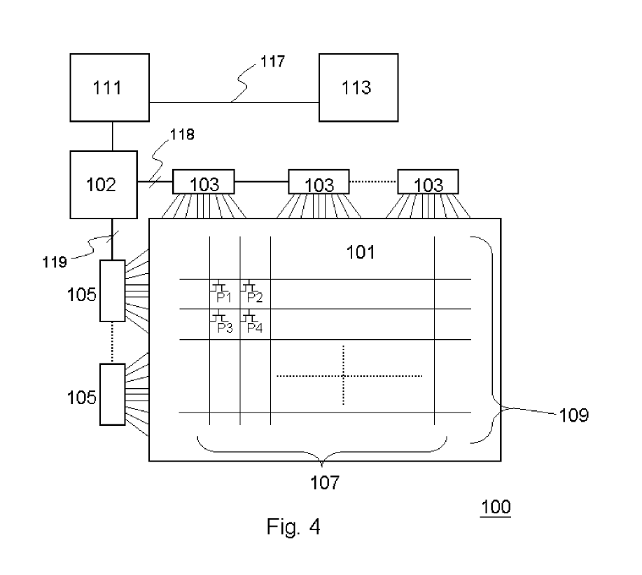

An electro-phoretic display system 100 is shown in FIG. 4. The electro-phoretic display system 100 includes a panel 101, a plurality of column lines 107, a plurality of row lines 109, a data driver 103, a selecting driver 105, a timing controller 102, a controller 111 and a memory 113. The plurality of column lines 107 and the plurality of row lines 109 are perpendicular to each other, and the intersection between each column line and each row line form a pixel. The selecting driver 104 can turn on one or more than one row lines corresponding to a pixel (or multiple pixels) need to be updated on the row line, and the data driver 103 updates the pixel through the corresponding data line. Please be noted, the data driver 103 and the selecting driver 105 can both be only one driver, and can be more than one driver if the display is large. The data driver 103 and the selecting driver 105 are electrically connected to the timing controller 102 through a data signal line 118 and a selecting signal line 119 respectively. The timing controller 102 sends a timing signal to both the data driver 103 and the selecting driver 105, and sends a data signal to the data driver 103.

The controller 111 retrieves image data from the memory 113. The controller 111 compares a current image with a previous image, and sends a control signal to the timing controller 102 to inform the timing controller 102 about the pixels which need to be updated. For example, please refers to FIG. 3, the controller 111 compares the data of Frame n with the data of Frame n+1, and outputs the difference, that is the Output Frame, to the timing controller 102. The memory 113 can be a DRAM (Dynamic Random Access Memory), SRAM (Static Random Access Memory), flash memory or other type of memory. The memory 113 can store both the current image and the previous image, and the controller 111 retrieves the current image and the previous image to make a comparison. In another embodiment, the memory 113 can only store the previous image, the controller 111 retrieves the data of the previous image from the memory 113 and receives the data of the current image from another storage media, e.g. hard disk, memory card, optical storage disk, massive storage device; or the controller 111 receives the data of the current image from an image receiving device, e.g. wireless network or broadcasting, and the controller 111 makes the comparison immediately.

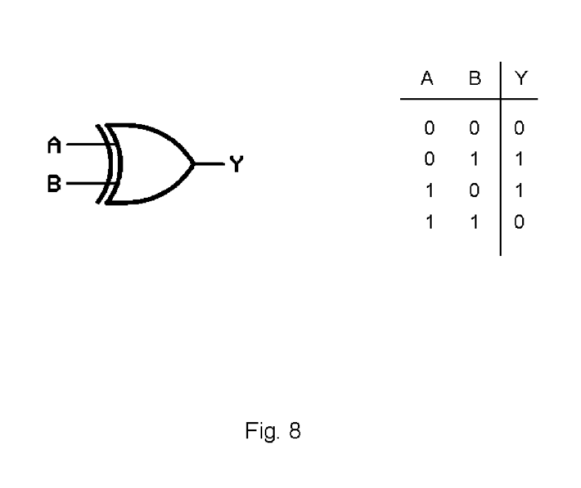

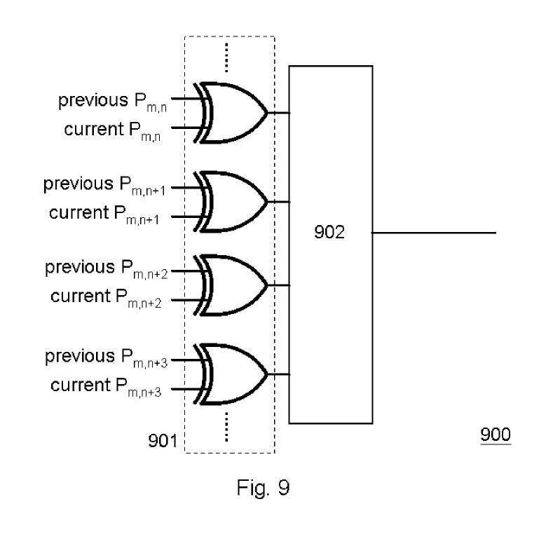

It's not hard for one having ordinary skills in the art to implement the above-mentioned comparison mechanism. In this embodiment, the controller 111 can comprise a plurality of XOR gates. FIG. 8 is a single XOR gate and its truth table. The XOR gate outputs “1” when two input values are different, and outputs “0” when two input values are the same. FIG. 9 is an example of the controller 111. The controller 900 in FIG. 9 comprises a plurality of XOR gates 901 and a converter 902. The plurality of XOR gates 901 receive previous pixel values (previous P_{m,n}, previous P_{m,n+1}, previous P_{m,n+2}, previous P_{m,n+3}) and corresponding position of current pixel values (current P_{m,n}, current P_{m,n+1}, current P_{m,n+2}, current P_{m,n+3}) to the input ends, then do logical operation of these pixel values. The converter 902 electrically connects to the output ends of the plurality of XOR gates 901 for receiving the logical operation results. The converter 902 converts the logical operation results to serial data with identifiable position information of the panel. Furthermore, the converter 902 can provide the pixel value of the pixel which needs to be updated to the timing controller 102. One way is the controller 900 has N XOR gates (M×N resolution panel) for receiving a complete row data each time, and outputs the logical operation results in series for each pixel of the row. The timing controller 102 can determine whether to update a pixel or not according to the logical operation results. For example, if the logical operation result of the first pixel is “1”, then the timing controller 102 updates this pixel according to the value of the pixel; if the logical operation result of the next pixel is “0”, then the timing controller 102 will do nothing to the next pixel. The number of XOR gates is not limited to the row length, for example. The number of XOR gates can be N/2, N/3 or other number, and the whole pixel data of a row will send to the plurality of XOR gates 901 separately.

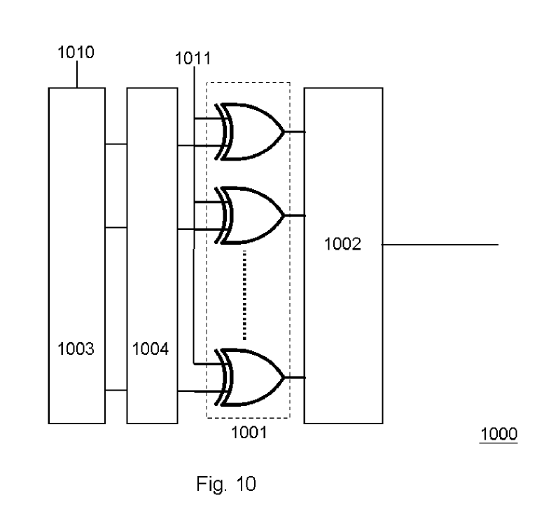

FIG. 10 is another example of the controller 111. In FIG. 10, the controller 1000 comprises a plurality of XOR gates 1001, a converter 1002, a first latch 1003 and a second latch 1004. The first latch 1003 receives a current frame data pixel by pixel from the input terminal 1010, when the first latch 1003 receive a row data of the current frame (or N/2, N/3 or N/other number of a row), the first latch 1003 will send the whole row data (or N/2, N/3 or N/other number of a row) to the second latch 1004. The plurality of XOR gates 1001 compares the row data (or N/2, N/3 or N/other number of a row) of the current frame with a row data (or N/2, N/3 or N/other number of a row) of a previous frame from the previous frame data input terminal 1011, then outputs the compared results to the converter 1002. The converter 1002 converts the compared results to serial data with identifiable location information of the panel. The timing controller 102 can update the pixels which need to be updated according the serial data.

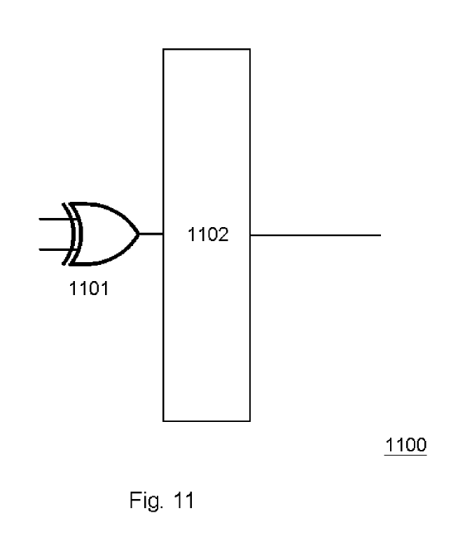

Another example of the controller 111 is utilized only one XOR gate to compare a pixel value of a pixel of a current frame with a pixel value of a corresponding pixel of a previous frame. The XOR gate outputs the compared result to the timing controller 102 pixel by pixel. Or the XOR gate 1101 outputs the compared result to a converter 1102 first, as shown in FIG. 11, and the converter 1102 converts the compared result to a serial data with identifiable location information of the panel, then the converter 1102 outputs the serial data to the timing controller 102 to update the pixel which need to be updated.

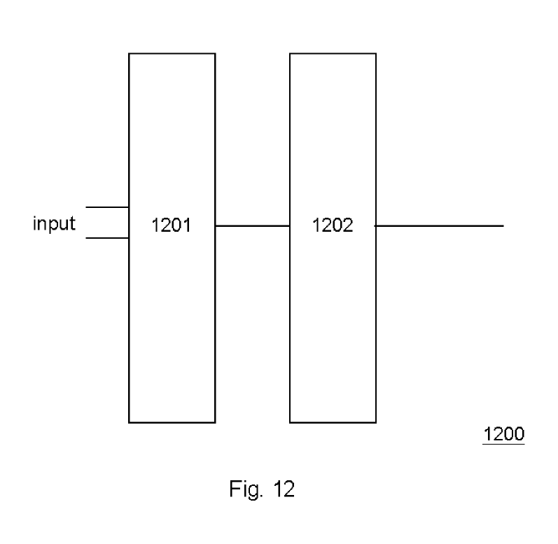

FIG. 12 is another example of the controller 111. In FIG. 12, the controller 1200 comprises a subtractor 1201 and a converter 1202. The subtractor 1201 receives previous pixel values and corresponding position of current pixel values to the input ends. The subtractor 1201 subtracts the previous pixels values and corresponding position of current pixel values, and outputs the results to the converter 1202. The converter 1202 electrically connects to the output end of the subtractor 1201 for receiving the results. The converter 1202 converts the results to serial data with identifiable location information of the panel.

Please be noted, the converter 902, 1002, 1102 and 1202 can also convert the compared results into addresses of the pixels which need to be updated. For example, each pixel of the panel can be given an address. The converter can only send out the addresses of the pixels which need to be updated without the compared results to the timing controller 102 to lower the transmission data amount, and the timing controller 102 updates the pixels corresponding to the addresses. The plurality of XOR gates can be replaced by other logic gate or combined logic gates, such as AND gate or OR gate, and the subtractor can be replaced by other comparison device. The forms of the converted data mentioned above, the logic gate and the subtractor are only examples, and shall not limit the scope of this invention.

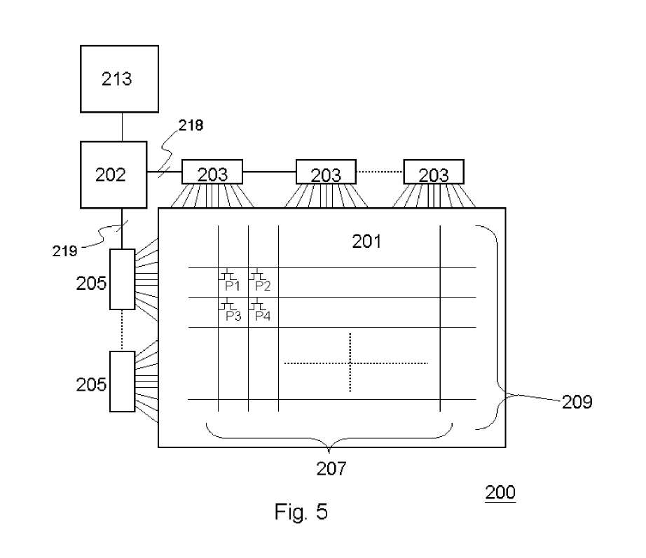

A second embodiment according to this invention is shown in FIG. 5. An electro-phoretic display system 200 is shown in FIG. 5. The electro-phoretic display system 200 includes a panel 201, a plurality of column lines 207, a plurality of row lines 209, a data driver 203, a selecting driver 205, a controller 202 and a memory 213. The plurality of column lines 207 and the plurality of row lines 209 are perpendicular to each other, and the intersection between each column line and each row line form a pixel. Please be noted, the difference between FIG. 4 and FIG. 5 is that the controller 202 receives the pixel data from the memory 213, compares the current frame with previous frame and sends a timing signal to both the data driver 203 and the selecting driver 205, and sends a data signal to the data driver 203. In other words, the timing controller is embedded into the controller 202.

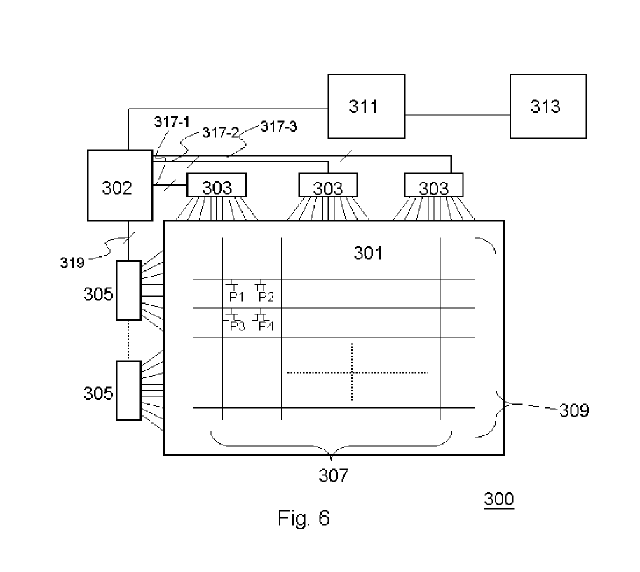

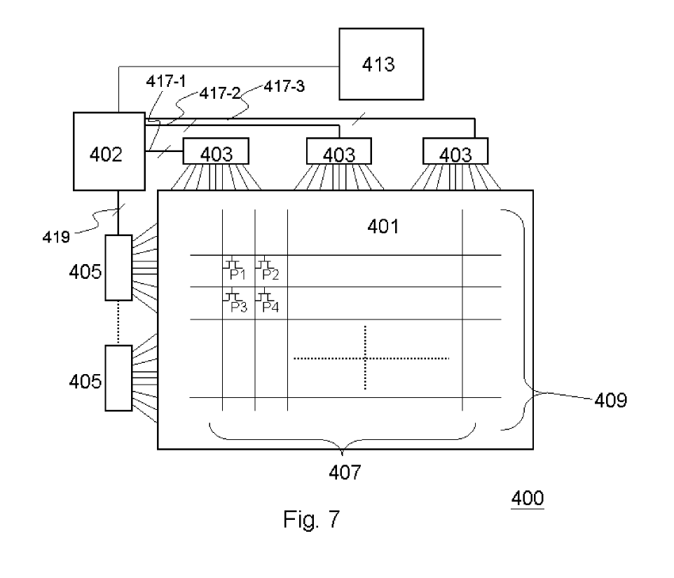

FIG. 6 and FIG. 7 show third and fourth embodiments of the present invention. The third embodiment is corresponding to the first embodiment, and the fourth embodiment is corresponding to the second embodiment. The only difference between the third embodiment and the first embodiment is that in the first embodiment, the timing controller 102 is connected to the first data driver 103 (the leftist one), and the second data driver (the one on the right side of the leftist one) is connected to the first data driver 103. The timing controller 102 sends the data signals to the first data driver 103, and the first data driver 103 passes the data signals to the second data driver 103. But in the third embodiment, the timing controller 302 is connected to the first data driver 303 (the leftist one) and the second data driver 303 (the one on the right side of the leftist one) directly. The timing controller 302 directly sends the data signals to the first data driver 303 and the second data driver 303. The difference between the fourth embodiment and the second embodiment is similar to the difference between the third embodiment and the first embodiment, and will not narrate here again. 4

Please be noted, the examples of controller according to FIG. 9, FIG. 10, FIG. 11 and FIG. 12 can also use in the second, the third and the fourth embodiments. FIG. 9, FIG. 10 and FIG. 11 are only examples, shall not limit the scope of this invention.

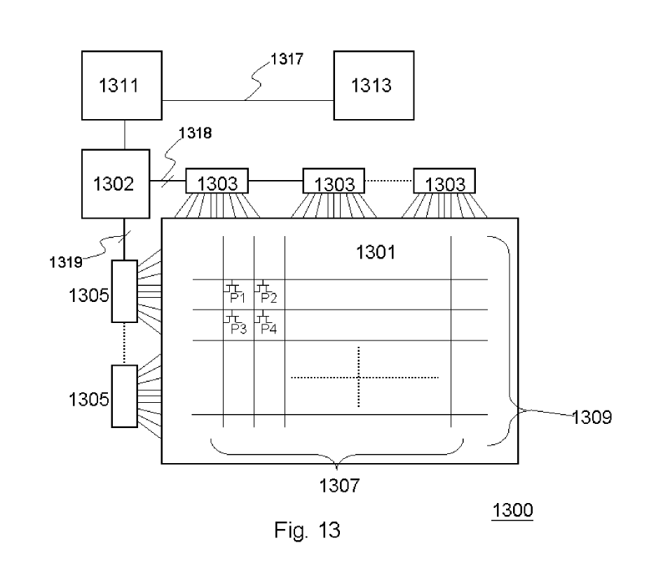

A fifth embodiment according to the invention is shown in FIG. 13. An electro-phoretic display system 1300 is shown in FIG. 13. The electro-phoretic display system 1300 includes a panel 1301, a plurality of column lines 1307, a plurality of row lines 1309, a data driver 1303, a selecting driver 1305, a timing controller 1302, a controller 1311 and a storage 1313. The plurality of column lines 1307 and the plurality of row lines 1309 are perpendicular to each other, and the intersection between each column line and each row line form a pixel. The difference between the first embodiment and the fifth embodiment is the storage 1313 of the fifth embodiment stores a compressed image data. The compressed image data may comprise an initial frame (e.g. Frame n in FIG. 3) and several difference frames (e.g. Output frame in FIG. 3). Please be noted, the initial frame and the difference frame can be further compressed. The initial frame can be compressed by intra frame compression method, for example, JPEG, GIF, TIFF etc. The difference frame may contain many “0” or “1”, so the difference frame can be compressed into small data mount. The controller 1311 receives the initial frame and output the initial frame to the timing controller 1302 for displaying the initial frame. The controller 1311 then receives the second frame, the difference frame, and the controller 1311 converts the difference frame to a data that the timing controller 1302 can identify which pixel need to be updated. The timing controller 1302 sends a control signal to the data driver 1303 and to the selecting driver 1305 to update the pixels which need to be updated. The second, third and fourth embodiments can also utilize the compressed image data to update the pixels which need to be updated, the control methods are similar, and will not narrate here again.

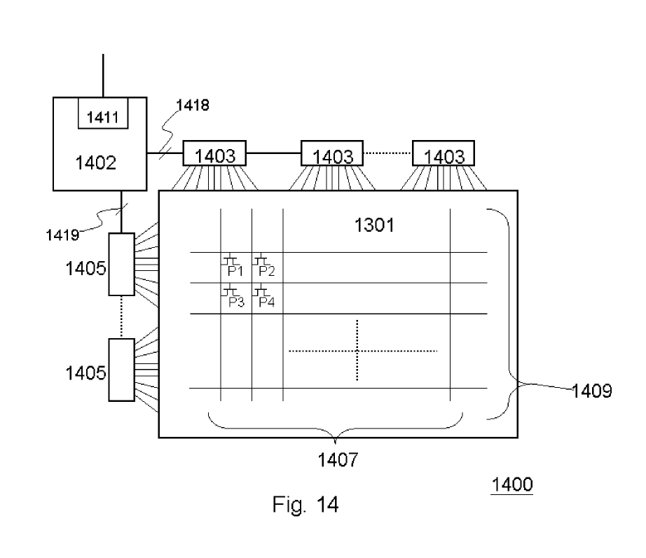

A sixth embodiment according to the invention is shown in FIG. 14. An electro-phoretic display system 1400 is shown in FIG. 14. The electro-phoretic display system 1400 includes a panel 1401, a plurality of column lines 1407, a plurality of row lines 1409, a data driver 1403, a selecting driver 1405 and a timing controller 1402, the timing controller 1402 further comprises a receiver 1411. The plurality of column lines 1407 and the plurality of row lines 1409 are perpendicular to each other, and the intersection between each column line and each row line form a pixel. The difference between the fifth embodiment and the sixth embodiment is the timing controller 1402 receives a compressed image data directly, either from a memory, a massive storage device, such as an optical storage device or a hard disk, or from a cable, network or broadcast. The compressed image data may comprise an initial frame (e.g. Frame n in FIG. 3) and several difference frames (e.g. Output frame in FIG. 3). The timing controller 1402 receives the initial frame from the receiver 1411 for displaying the initial frame. The timing controller 1402 then receives the difference frame, and sends a control signal to the data driver 1403 and to the selecting driver 1405 to update the pixels which need to be updated. The second, third and fourth embodiments can also utilize the compressed image data to update the pixels which need to be updated, the control methods are similar, and will not narrate here again.

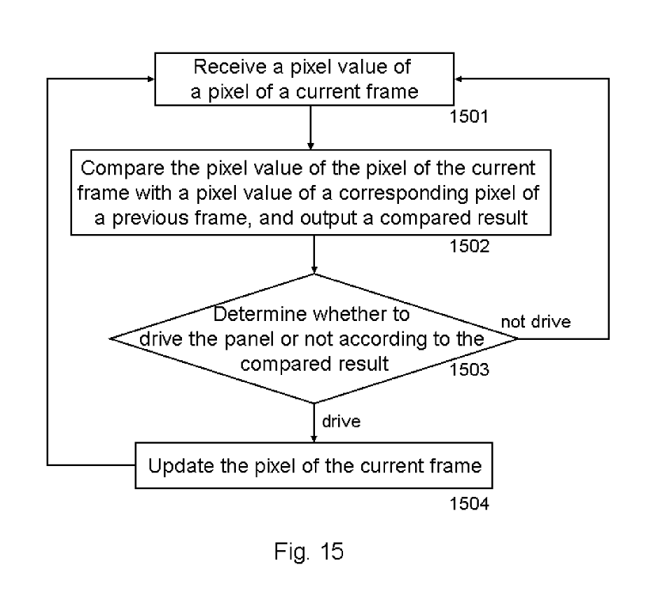

FIG. 15 shows a flowchart of a method for driving an electro-phoretic display according to the present invention. The electro phoretic display comprises an electro-phoretic display, a controller, a column driver, a row driver and a memory. As shown in step 1501, the controller receives a pixel value of a pixel of a current frame. The controller compares the pixel value of the pixel of the current frame with a pixel value of a corresponding pixel of a previous frame, and outputs a compared result as shown in step 1502. Please be noted, the controller can receive only one pixel value and compare one pixel value at one time, or receive a plurality of pixel values and compare a plurality of pixel values at one time. The pixel value of previous frame is stored in the memory. The controller then determines whether to drive the electro-phoretic panel or not according to the compared result as shown in step 1503. Please be noted, the compared result can be obtain by logical operation or by subtracting. For example, if the value of the first pixel of the current frame is different from the value of the first pixel of the previous frame, the first pixel will be updated; if the value of the second pixel of the current frame is equal to the value of the second pixel of the previous frame, at least some of this kind of pixel will not be updated. In some case, the value of a specific pixel has not changed for a certain period, although the value of the specific pixel of a current frame is equal to the value of the specific pixel of a previous frame, the pixel will be updated. Please note, the compared result could be an initial frame and a difference frame as shown in FIG. 3. The initial frame can be compressed by intra frame compression method, for example, JPEG, GIF, TIFF etc. The difference frame may contain many “0” or “1”, so the difference frame can be compressed into small data amount. In step 1504, if the controller determines the pixel need to be driven, the column driver and the row driver will update the pixel; if the controller determines the pixel does not need to be driven, then back to receive a next pixel value of another pixel in step 1501. Please note, if the pixel value of the pixel of the current frame is equal to the pixel value of a corresponding pixel of the previous frame, the compared result could represent “not drive”; if the pixel value of the pixel of the current frame is not equal to the pixel value of the corresponding pixel of the previous frame, the compared result could represent “drive.”

Those skilled in the art will readily observe that numerous modifications and alterations of the device and method may be made while retaining the teachings of the invention.

What is claimed is:

1. A electro-phoretic display comprising:
an electro-phoretic panel;
a column driver;
a row driver, for selecting a row to be driven; and
a controller, for determining whether to update a pixel of a current frame according to a compared result between a pixel value of the pixel and a pixel value of a corresponding pixel of a previous frame;
wherein, the column driver provides a data signal to the pixel and the row driver provides a selecting signal according to the pixel if the pixel needs to be updated.

2. The electro-phoretic display of claim 1, wherein the controller further comprises a timing controller, for generating a timing signal and rendering the data signal and selecting signal to the column driver and the row driver respectively.

3. The electro-phoretic display of claim 1 further comprises a memory, for temporary storing the previous frame.

4. The electro-phoretic display of claim 1 further comprises a memory, for temporary storing the previous frame and the comparison result.

5. The electro-phoretic display of claim 1 wherein the controller further comprises a subtractor, for subtracting the pixel value of the pixel from the pixel value of the corresponding pixel of the previous frame to generate the comparison result.

6. The electro-phoretic display of claim 5 wherein if the pixel value of the pixel is different from the pixel value of the corresponding pixel of the previous frame, the controller determines that the pixel needs to be updated.

7. The electro-phoretic display of claim 1 wherein the controller further comprises a XOR gate, for doing logical operation of the pixel value of the pixel and the pixel value of the corresponding pixel of the previous frame, and generating the compared result.

8. The electro-phoretic display of claim 1 wherein the display further comprises a timing controller, for generating a timing signal and rendering the data signal and selecting signal to the column driver and the row driver respectively.

9. A display system comprising:
a data receiver, for receiving an image data, the image data comprising an initial frame and a difference frame, wherein the difference frame and the initial frame define a second frame;
an electro-phoretic display comprising:
an electro-phoretic panel;
a column driver;
a row driver; and
a timing controller, for controlling the column driver and the row driver to display the initial frame on the electro-phoretic panel and updates a plurality of pixels of the initial frame according to the difference frame to display the second frame.

10. The display of claim 9 further comprises a controller, for converting the image data into a control signal, and the timing controller controls the column driver and the row driver according to the control signal.

11. The display of claim 9 further comprises a memory, for storing the image data.

12. The display of claim 9, wherein the image data is a compressed image data.

13. The display of claim 9, wherein the data receiver electrically couples to a cable.

14. The display of claim 9, wherein the data receiver electrically couples to a network.

15. The display of claim 9, wherein a data of the difference frame is compressed.

16. A method of driving an electro-phoretic display comprising:
driving the electro-phoretic display to display a previous frame; and
determining whether to update a pixel of a current frame according to a compared result between a pixel value of the pixel of a current frame and a pixel value of a corresponding pixel of a previous frame.

17. The method of claim 16, wherein the step of determining whether to update a pixel comprises:
updating a first pixel if the value of the first pixel of the current frame is different from the value of the first pixel of the previous frame, and not updating at least a second pixel if the value of the second pixel of the current frame is equal to the value of the second pixel of the previous frame.

18. The method of claim 16, further comprising:
receiving the compared result from a device outside of the electro-phoretic display.

19. The method of claim 16, wherein the compared result is a difference frame, and the difference frame and the previous frame define the current frame.

20. The method of claim 17, wherein a data of the difference frame is compressed.
